(19) United States
(12) Patent Application Publication
(10) Pub. No.: US 2015/0199300 A1
(43) Pub. Date: Jul. 16, 2015

(54) Jolt and Jar Recorder System

(71) Applicant: LEXINGTON-APAAC, LLC, Philadelphia, PA (US)

(72) Inventor: Dean Picciotti, Philadelphia, PA (US)

(73) Assignee: Lexington Technology Auditing, Inc., Philadelphia, PA (US)

(21) Appl. No.: 13/767,895

(22) Filed: Feb. 15, 2013

(51) Int. Cl. G06F 17/00

(52) U.S. Cl. CPC G06F 17/00

(57) ABSTRACT

A system for monitoring and recording vehicle data constantly during operation, which combines, stores and analyzes data. The invention typically comprises a recording device connected to a variety of systems which may include vehicle status, video, audio or other interfaces. Data may then be selectively retrieved wirelessly and stored in an encrypted manner to preserve authenticity. Data collected could also include: temperature (inside and outside); weather conditions; tire slip; roll, yaw, pitch; altitude; speed and changes to speed; GPS data; any available Radio Signals and the strength and source of those signals; vibration; sound level and changes; air pressure; light and changes; intrusion; moisture; humidity; inertia/gravitational forces; vehicle (OBD) error codes; vehicle weight; tire pressure; location of the device within the vehicle; engine RPM (and other OBD available data); Time/Date. These data can be combined to analyze driver performance or verify the existence of a claimed accident.

### CROSS REFERENCE TO RELATED APPLICATION

The present application claims benefit of priority from U.S. Provisional Patent Application 61/742,629 filed Aug. 15, 2012, which is expressly incorporated herein by reference.

### FIELD OF THE INVENTION

The present invention relates generally to a system for electronic monitoring, data collection and analysis in relation to a variety of vehicular data including video and/or physical data. In particular, the present invention relates to a system wherein a variety of receivers and devices acquire and store data continuously in an encrypted manner suitable for later use in forensic animation or other systems.

### BACKGROUND OF THE INVENTION

Unsafe driving causes significant costs in terms of direct loss, consequential loss, and societal loss due to a multitude of issues that must be dealt with in the aftermath. One major portion is the allocation of responsibility for direct costs. For example when more than one vehicle is involved, the determination must be made which vehicle is at fault and is thus generally held liable for the damages. As another example, if a passenger on a mass transit vehicle is injured it is important to determine whether the passenger or the operator or the Transit Authority is negligent (or the apportionment of negligence between them). While negligent operation of a vehicle represents a dangerous threat for private individuals, it is exponentially more difficult for transportation entities due to the number of vehicles in operation and the number of miles each vehicle operates annually. Traditionally, accident prevention and monitoring concepts have focused heavily on individual private vehicles and determining fault or in the alternative, on protecting private vehicles from theft. While these concepts are practical for individuals, they do not address the more complex concerns of transportation related organizations, such as those that run public transportation or larger commercial transportation operations.

Causation of driving injuries is particularly important for assigning responsibility, evaluating risk, and designing preventative methods. Currently, determining the cause of injuries, such as those involving a single vehicle, automobiles, trucks, and railroad rolling stock is very difficult. While accident investigation art has developed dramatically in recent years, much information gained in accident investigation is typically not factual and open to a variety of interpretations.

As an example of the difficulties encountered in an injury investigation, it is not uncommon for a passenger injury to occur with either no witnesses to the incident or, if there were witnesses, they are unidentified. Also, it is a well-known phenomenon that several witnesses who see the same accident often provide different interpretations. As another example, a vehicle may be so badly damaged that it is not possible to determine the effect of a mechanical failure in causing or aggravating an accident. In still another example, speed factors, braking factors, swerving factors which accident investigators consider vital in determining the cause of an accident, are difficult to ascertain. While the extent of damage to a vehicle and length of skid marks are often valuable indicators of speed, they are open to conjecture because of other factors, such as the amount of damage on the vehicle before the accident occurred and the distance a vehicle travels before a driver applies brakes to cause skid marks. Further, where the vehicle is aggressively stopped but no skidding occurs due to speed or environmental conditions (snow, rain) they are of no use.

With public and commercial transportation, the major concern shifts from assigning fault of the accident to passenger liability. Injuries may arise by improper operation of the transportation vehicles or through accidents not due to the fault of the driver. A major problem for transportation organizations lies with individuals who claim to have sustained injury while riding the vehicle, but may not have been present or are making up the incident. Further, notice of injuries may not be made available until many months after the event as the end of the statute of limitations draws near. A means for monitoring the operation of the vehicle, as well as a multitude of status indicators, which may be used to provide information related to the vehicles operation at the exact moment in question would be extremely useful to the mitigation of liability issues. A monitoring system that is able to determine and report the vehicle status at the exact moment in time that the former passenger claims to have been injured would allow transportation authorities to confidently settle legal matters based on irrefutable information concerning the operation of the vehicle in question and whether it was being operated within federally mandated thresholds. Further, it is necessary that the information be retrievable for a period that exceeds the statute of limitations for the relevant jurisdiction.

Automobile accident detection systems themselves are relatively common in the art. Upon the occurrence of an automobile accident, typical detecting systems may obtain pictures, video images and sounds of the accident and record the time of the accident and the status of the traffic lights at the time the accident occurred. This information can then be sent to a remote location where emergency crews can be dispatched. The information may be further examined and forwarded to authorities in order to determine fault and liability. Such detection systems are location specific and often set up in specific intersections, resulting in only a limited number of accidents occurring within a detection zone. Further, outfitting every intersection with accident detection would be extremely costly and generate enormous amounts of data. It is possible to monitor locations that are likely places for accidents to occur, however, without intelligence, this process may be inefficient and unproductive. Likewise, without immediate and efficient communication of the information obtained, benefits of the monitoring are quite limited.

In other instances, accident detection systems are centered on monitoring and controlling a limited number of statistics related to a particular vehicle, such as the acceleration or G-forces. While these may be suitable for single private vehicles, they are insufficient in how and what is retained. Alternatively, a number of prior art techniques are available for predicting the occurrence of an accident. Some of these require an extended period for an automated system to analyze the data, and thus substantially delaying any report generated. In others, the accuracy of the system depends on environmental conditions, such as lighting or time of day. While these systems may prove useful for urban planning or in other city development functions, they do not address any of the liability issues that transportation entities encounter.

What is needed is an apparatus and method to provide a user with readily accessible refined vehicle operation information without the problems associated with hand recording. Also needed is an apparatus and method to automatically provide comprehensive and factual vehicle operational and accident data to enhance an accident investigator's ability to determine cause and legal liability. There is currently a void in the art for vehicle centric accident detection and monitoring systems, capable of storing sufficient data so as to provide legal support for large transportation organizations. The present invention fills this void, by addressing all the substantial needs of larger transportation organizations, while providing an economical, accident detection and recreation system that will preserve valuable data for legal challenges arising over time.

The present invention is a physical device or software integrated with other physical devices, capable of collecting and independently recording GPS coordinates, velocity, acceleration, time and other information. Radio frequency information and other electronic data may be collected as well to be used to determine the presence and location of an individual. This might include signals such as those emitted from cellular phones. Additionally, the present invention describes a method for recording and storing said data with encryption and authentication techniques for later use in recreating the specific movements of the vehicle. Collected data is tagged and time-stamped in a manner allowing precise alignment with video and audio recordings. The device may be employed on vehicles, to record data in perpetuity, for later retrieval and may also be integrated with forensic animation or other software.

There are a number of ways in which vehicle statistics, such as speed and distance, may be tracked. For instance, speedometers, accelerometers, GPS technologies and OBD-II ports are currently available in some or all vehicles. OBD-II ports, for example, are available in all post-1996 vehicles. An OBD-II port is a standardized digital communications port designed to provide real-time data regarding vehicle functioning in addition to a standardized series of diagnostic trouble codes. This data may be collected by connecting a device to the OBD-II port that is capable of communicating using, for example, the SAE J1850 standard.

The present invention's primary intended use is the collection of forensic quality data for the determination of the physical experience of vehicle riders, and, more specifically, if passengers have been exposed to unusual vehicle behavior including swerving, sudden stops, assorted bumps, and unexpected movements. The data collected by the present invention allows a determination to be made of the specific movements of the vehicle during a specified time period. The time period may be flagged for review during the occurrence, immediately after or anytime in the future when analysis is needed.

In particular, the data may be used for introduction into courtroom evidence. Still more specifically the evidence may be used to defend plaintiff's personal injury cases based on soft tissue damage or other physical injuries. Further, the present invention may encrypt and authenticate the data collected to preserve the integrity and validity of the information for courtroom use. Additionally, the present invention may be used to detect and analyze flaws in vehicle design.

The present invention may collect this information from the physical device or from other in-vehicle sensors, encode the data using encryption to prevent tampering and to ensure admissibility in court, and then store the data on re-writable media, either a hard drive or flash memory.

Following collection of the data the device will generate a data checksum using a combination of the date and a hard-coded system ID as a ‘salt’, thus indelibly linking the collected information to both the device and the vehicle the device was located in.

This device also contains a wired and wireless network capability with the ability to upload and download data and other electronic communications in both real time, and post ride data processing.

With the necessity of maintaining data archives for a large number of vehicles for a multitude of years, another problem arises. Data, particularly encoded video, necessitates massive storage facilities and large numbers of data storage servers. The present invention addresses this issue, by allowing the separation of vehicle data, which takes up relatively little space, from the much larger video. By not saving the video beyond the initial storage on the vehicle, the accident data may be archived in an extremely efficient manner.

Additional objects, features, and advantages of the invention will become apparent to those skilled in the art upon consideration of the following detailed description of a preferred embodiment exemplifying the best mode of carrying out the invention as presently perceived.

### DESCRIPTION OF THE PRIOR ART

Numerous patents have issues and applications published in the field of vehicle monitoring. While relevant to the field in general, these prior art devices and systems each have drawbacks and fail to address the needs of larger transportation providers addressed by the present invention. The present invention addresses both the need for maintaining accident and anomaly data, as well as the need for historical, cumulative, and real-time vehicle monitoring. Both of these functions fill voids in the current art.

Several inventions address accident monitoring for a single private personal vehicle or for multiple vehicles, however, these inventions rely upon external cameras or microphones and constant monitoring. Reliance on external devices at intersections makes monitoring costly and difficult.

A variety of patents and publications address in-vehicle status monitoring in a limited manner that is not suitable for use by larger transportation entities. These patents typically monitor vehicles, look for deviations in performance and alert those supervising the vehicles of changes. These inventions do not provide for sufficient means of storage and retrieval to satisfy the human safety and litigation needs of a larger transportation entity.

Ogino, U.S. Patent Publication No. 2010/0250052, is directed toward an in-vehicle monitor for monitoring a status of a vehicle. The invention comprises a monitoring means for monitoring the status of the vehicle; a determination means for determining based on the status of the vehicle whether an obstacle interrupts an operation of an operation object when a user inputs an operation instruction for operating the operation object; and a controller for controlling the operation object to execute the operation corresponding to the operation instruction when the determination means determines that the obstacle does not interrupts the operation, and for controlling the operation object to execute another operation different from the operation corresponding to the operation instruction when the determination means determines that the obstacle interrupts the operation.

Lemelson, U.S. Pat. No. 4,671,111, is directed to a vehicle performance monitoring system employing one or more accelerometers operative to generate output signals of acceleration and deceleration of a vehicle as the vehicle operates. Such signals are electronically processed and either immediately analyzed by a computer prior to monitoring or recording same or are recorded and later analyzed by an onboard computer or a remote computer which communicates with a memory part of the system located in the vehicle. Data is communicated by pluggable lines or short wave communication.

Nicol et al., U.S. Pat. No. 5,548,273, is directed toward an apparatus for monitoring operation a vehicle apparatus includes sensors for sensing G-forces on the vehicle and for generating output signals proportional to a forward G-force, a reverse G-force, a left direction G-force, and a right direction G-force on the vehicle. The apparatus permits an authorized user to set a selected maximum G-force limit for each direction. The apparatus stores G-force output signals generated by the sensors which are higher than the maximum selected limit for each direction. An oven heats each sensor to a substantially constant predetermined temperature, thereby improving the accuracy of the output signals from the sensor upon fluctuation of an ambient temperature adjacent the apparatus. The apparatus detects when the apparatus has been disconnected from a power supply to alert an owner of the vehicle that the vehicle may have been driven without the monitoring apparatus in operation.

The Orgino, Lemelson and Nicol patents each describe inventions which monitor a single vehicle and provide immediate or delayed alerts to a supervisor should deviation from the defined parameters occur. While these inventions might prove useful in smaller and more personal situations, they suffer from several issues that make them unsuitable for use with a large transportation entity. Primarily, they do not provide for storage beyond that designated immediately within the vehicle. This severely limits capacity for video, pictures and other data storage. The present inventions fills this void, by providing a secure monitoring system capable of maintaining data for years, in a manner suitable to courtroom use.

Kikinis, U.S. Pat. No. 5,815,093, is directed toward a vehicle accident recording system employs a digital camera connected to a controller, a non-volatile memory, and an accident-sensing interrupter. The controller accesses images from the digital camera periodically and stores the images in a limited space of n sectors. After all n sectors are filled, each new image is overwritten to the oldest stored image. In the event of an accident, the interrupter causes the operation of storing images to cease. The result is a recorded history of n images spanning a time period up to the incidence of an accident of the number of images stored times the average time period between images. In a preferred embodiment the system has a communication port whereby the stored images may be downloaded after an accident to a digital device capable of displaying the images, thereby providing a visual record of the time period immediately preceding an accident. In alternative embodiments vehicle operating data is recorded, positional information is accesses and recorded, and on-board control routines convert raw data to meaningful information.

The Kikinis invention suffers from a similar issue to the Orgino, Lemelson and Nicol patents. The control in the Kikinis invention saves a plurality of pictures taken in the time leading up to a crash event. Saving pictures, helps preserve space, and attempts to substitute for video. However, the Kikinis invention fails to provide a means to preserve multiple video recordings related to the accident for a long term. Additionally, there is no means of encryption, meaning that data, while informative, may suffer evidentiary issues if it is to be used in a legal setting.

Tuff, U.S. Pat. Nos. 7,853,375 and 8,180,522, are directed toward a system and method for monitoring a motor vehicle. The system includes a sensor unit for collecting at least one vehicle statistic and a portable device for displaying the vehicle statistics. The portable device requests the vehicle statistics from the sensor unit at regular intervals or in response to a particular event and displays statistics on a built-in display screen. In one embodiment, the portable device may be attached to the keys used to operate the vehicle being monitored.

The Tuff patents provide for inventions that monitor basic vehicle statistics and store the information in a small onboard unit such as a key chain with internal memory. While these devices are useful for compiling basic information regarding vehicle performance, they are not designed with the intent to monitor or detect accidents. In particular they are not capable of providing complete, accurate data which might be useful in a court of law. The present invention provides such data, and stores said data in a manner allowing years of records for hundreds of vehicles to be accessed and used as needed, something which is the Tuff inventions are simply not designed for.

Oyagi et al., U.S. Pat. No. 7,212,103, is directed toward a monitoring system which can monitor a plurality of vehicles including vibration sensing units, each sensing a vibration of the associated vehicle, a sensed time specifying unit, which specifies an instant at which the vibration of the vehicle is sensed by the vibration sensing unit, and an abnormality determining unit which determines, when a vibration of one of the vehicles is sensed by the associated vibration sensing unit, whether the vibration is caused by preparations for theft with respect to the vehicle or the vibration is caused by environmental influences on the vehicle. The abnormality determining unit carries out the determination of ground of sensing results obtained by the vibration sensing units of the respective vehicles and a result of specification carried out by the sensed time specifying unit. With this, a possibility of incorrectly identifying a vibration not being attributed to preparations for theft as a vibration attributed to preparations for theft.

Other inventions in the prior art, such as the Oyagi invention, are directed toward detecting a single sort of event, in this instance vibration. This is useful for theft prevention, but does not accomplish the goal of monitoring a large fleet of vehicles for accidents. Like the other previously mentioned prior art, the Oyagi invention does not provide for a means archiving and retrieving information in a manner suitable for courtroom usage.

Other patents isolate single locations for monitoring, such as a parking lot or intersection. For example, Japanese Patent Application No. 8-162911 entitled “Motor Vehicle Accident Monitoring Device”, discloses a system for monitoring traffic accidents including a plurality of microphones and video cameras disposed at an intersection. Collision sounds are chosen from among the typical sounds at an intersection. The source of the collision sounds is determined by comparing the time differences of the sounds received by each of the microphones. Image data from the cameras is recorded upon the occurrence of the collision. However, the Japanese reference discloses a system that is constantly photographing and recording the accident scene thereby wasting resources.

Similarly, Lagassey, US Patent Publication No. 2008/0252485 and U.S. Pat. No. 7,348,895, are directed toward a system for monitoring a location to detect and report a vehicular incident. The Lagassey inventions comprise a transducer for detecting acoustic waves at the location with an audio output; and a processor for determining a probable occurrence or impending occurrence of a vehicular incident, based at least upon said audio output. The invention further comprises an imaging system for capturing images of the location, and having an image output; a buffer, receiving said image output, and storing at least a portion of said images. The images stored commence at or before said determination of an accident and are selectively sent via a communication link, to a remote location with information identifying the location. Information stored in said buffer is preserved at least until an acknowledgement of receipt is received representing successful transmission through said communication link with the remote location.

These applications rely on outfitting each intersection with devices to observe and detect accidents. While this has some utility, only accidents in those intersections will be recorded. The present invention provides constant monitoring of all vehicles in the fleet, which allows accidents to be recorded at any intersection. Additionally, the present invention preserves all the information related to a particular bus allowing it to be accessed at a future date should litigation arise.

### SUMMARY OF THE INVENTION

The present invention is a physical device or software integrated with other physical devices, capable of collecting and independently recording GPS coordinates, velocity, acceleration, deceleration, changes in sound (DB meter), vibrations, pitch, yaw, time, identifiable radio signals and other electronic information. Further, the present invention describes a method for recording and storing said data with encryption for later use in recreating the specific movements of the vehicle. The device may be employed on vehicles, to record data in perpetuity, for later retrieval and may also be integrated with forensic animation or other software. In particular, the data may be used for introduction into courtroom evidence. Still more specifically the evidence may be used to defend plaintiff's personal injury cases based on soft tissue damage. Further, the present invention may encrypt the data collected to preserve the integrity and validity of the information for courtroom use.

The present invention's primary intended use is the collection of forensic quality data for the determination of the physical experience of vehicle riders, and, more specifically, if passengers have been exposed to unusual vehicle behavior including swerving, sudden stops, assorted bumps, and unexpected movements. The data collected by the present invention allows a determination to be made of the specific movements of the vehicle during a specified time period. These movements included typical accelerations and decelerations, as well as any sudden jolts, jars or other movements that may be associated with an accident.

The present invention may collect this information from the physical device or from other in-vehicle sensors, it then encodes the data using encryption and authentication means to prevent tampering and to ensure admissibility in court, and stores the data on re-writable media, either a hard drive or flash memory.

The device will generate a data checksum using a combination of the date and a hard-coded system ID as a ‘salt’, thus indelibly linking the collected information to both the device and the vehicle the device was located in. Additionally, the device is outfitted with an authentication means to determine where in the vehicle the device is situated. This authentication allows the information collected to be matched with a specific device, which may be necessary in instances in which there is more than a single device on a vehicle (multicar train, double bus).

This device also contains a wired and wireless network capability with the ability to upload and download data and other electronic communications in both real time, and post ride data processing.

It is therefore an object of the present invention to provide a physical device or system to monitor the movements of a vehicle, including the status and video footage.

Another object of the present invention is to provide an efficient and economical means to store and maintain the data until the statute of limitations period is exceeded, in a manner that is efficient and economical.

Yet another object of the present invention is to provide a means to use the data with forensics software, such that the data is admissible in court, for legal proceedings.

Other objects, features and advantages of the present invention will become apparent from the following detailed description taken in conjunction with the accompanying drawings

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 is a flow chart outlining the process by which the present invention records and preserves data.

FIG. 2 is a flow chart outlining the process by which data is decrypted for use in court proceedings.

### DETAILED DESCRIPTION OF THE INVENTION

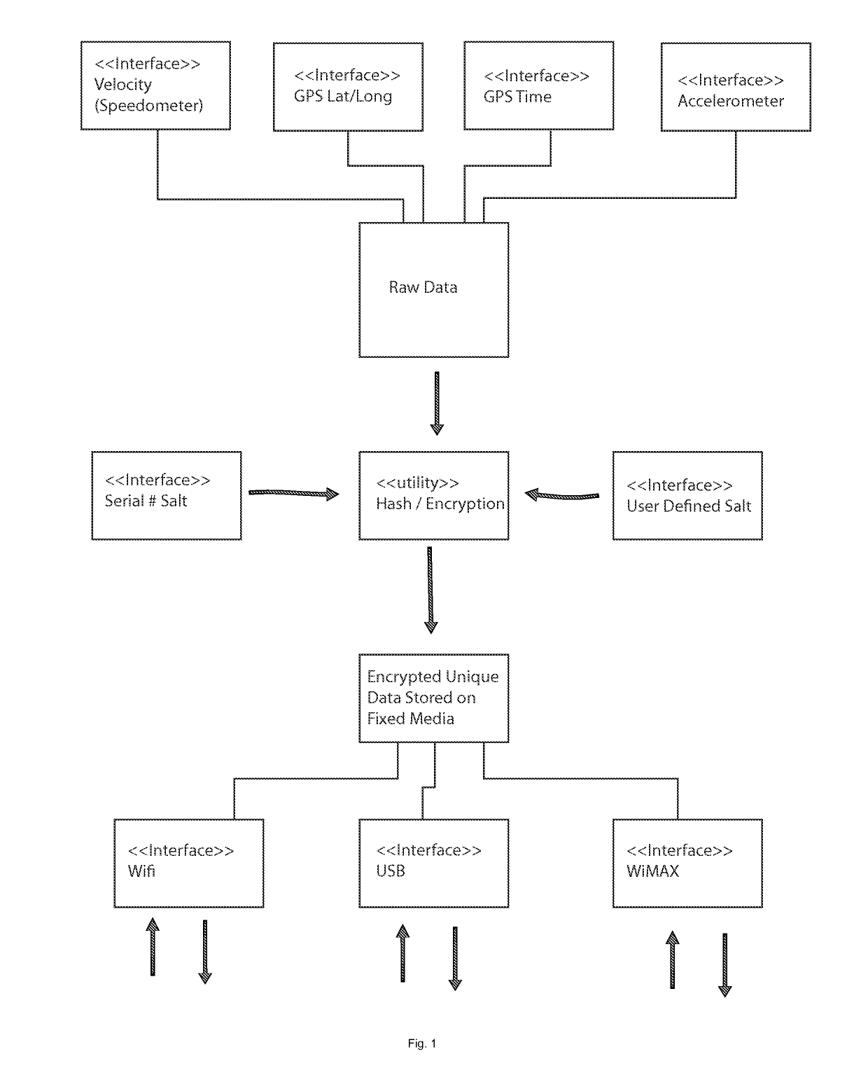

Referring now to FIG. 1, there is shown a flow chart outlining the process by which the present invention records and preserves data. The present invention provides that a variety of in vehicle interfaces record and store data for a transportation vehicle. These interfaces may include video cameras, GPS coordinates, a GPS Timestamp, an accelerometer as well as any other potentially useful status devices. The interfaces record and compile the raw data, then pass said data on to a hash/encryption utility. The data is then encrypted using a hash tag based on the vehicle, as well as another security tag. Once encrypted, the data is stored temporarily on the vehicle in a fixed media, such as a hard drive or flash drive.

Due to the size of the video data, it is neither feasible nor desirable to transfer all data from each vehicle to a backend server. It is likely that each vehicle will have numerous cameras, each generating many gigabytes of video data each day. For this reason the video data will be separated from the data acquired by other interfaces. Video data will remain stored on the vehicle for a short time chosen by the user, likely 1-5 days, and the associated encrypted interface data can be efficiently transferred to a back server for preservation. The associated data collected by the interfaces will provide a sufficient encrypted means to recreate any suspected accidents in a manner that preserves the chain of evidence, such that the data is legally admissible in court.

The interface data may be retrieved using a variety of means, including connected or wireless data transfer. Most conveniently, a wireless method would represent the preferred means of transferring, as vehicles could park appropriately and allow an automated transfer of the interface data.

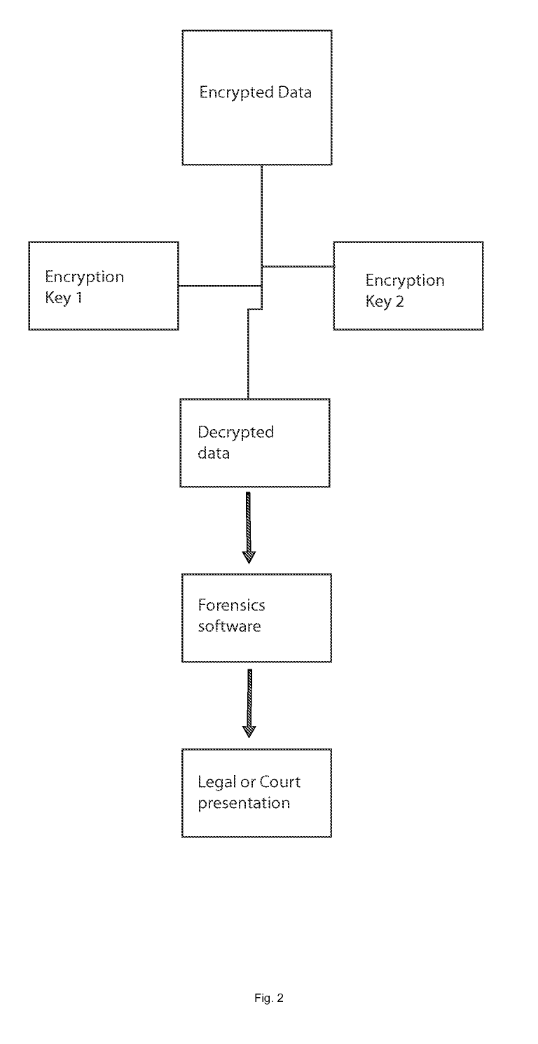

Referring now to FIG. 2, there is shown a flow chart demonstrating the extraction process of the data for court usage. Encrypted data can be decrypted using a series of keys, one likely defined by the user, and another held by the manufacturer and kept unknown absent court order. Should a court order be issued to decrypt the data, the code could be easily released. This preserves the chain of evidence and the integrity of the encrypted data such that it will serve as viable evidence in any court proceeding. The two keys are the applied to the encrypted data, decrypting the data to a format that may be used by forensic software to recreate the time period desired. The encryption could be utilized in a variety of manners. In a more basic sense, the encryption could leave any data collected un-encrypted, while encrypting and storing a checksum. This would allow changes to be detected, and allow the operating entity to make use of the data. In more sensitive situations the data might be completely encrypted, such that it may only be extracted when a legal need is present. The software may then be used to create a presentation as desired for courtroom use.

According to a first aspect of the present disclosure an in-vehicle monitor for monitoring a status of a vehicle including a status of an operation object, which is operated by a user, the monitor includes: a series of interfaces, including GPS coordinates, a GPS timestamp, an accelerometer, video recordings and any other interface deemed useful. Data will be collected as the vehicle is operated, and will be stored for later use on the vehicle.

According to a second aspect of the present disclosure of an in-vehicle monitor for monitoring a status of a vehicle includes a means by which the data collected by the interfaces may be encrypted with a both a user (entity) defined and a hidden encryption key. The hidden key will be kept in an anonymous manner by a third party (such as the manufacturer) and released only upon order of the court.

According to one aspect of the present invention, data may be retrieved within a relatively short period of time (ex. 30 days) from the vehicle itself. These data, when retrieved from the vehicle will include both the interface data and any recorded video data. The period will be set to a relatively short period, during which time the video data will be preserved on the bus. A vehicle is likely to have a multitude of cameras, collecting many gigabytes of data each day. This information will be retrievable from the bus immediately following an accident should the need arise as well. However, the present invention innovates to fill a void in the art by providing a means of separating the video data from the interface data. The interface data is significantly smaller, and can easily be stored for many years following the date of its creation. This data may be retrieved should there be a need or question of liability. The interface data alone will be sufficient to determine if there was an anomaly in the operation of the vehicle on the day in question, allowing immediate retrieval of both the specific video and data for the incident.

According to another aspect of the present invention, there exists a means by which past interface data may be automatically or manually searched and flagged for potential anomalies. These anomalies may then be reviewed to assess any potential liability that may have arisen. One example of this behavior would include a search run to determine all times at which the vehicle exceeded the posted speed limit. The results of this search may be used both to assess any potential liability and to evaluate the performance of the driver. The data could also be used to assess flaws in vehicles, roads, or even designated routes. Further, should the vehicle be operated in an anomalous fashion (regardless of incident) the device will automatically retrieve and store the temporally related video

### EXAMPLE 1

### Transit Authority Bus

The present invention may, in a preferred embodiment, be deployed to monitor a public transit vehicle, such as a bus, train, plane or boat. The present example will focus on deployment of the system on a bus. A plurality of video cameras would be stationed at all necessary points on said bus, preserving their data to an on-board DVR device. Additionally, other interfaces such as an accelerometer, GPS locator and GPS timestamp may be installed. Data collected could also include: temperature (inside and outside); weather conditions; tire slip; roll, yaw, pitch; altitude; speed and changes to speed; GPS data; any available Radio Signals and the strength and source of those signals; vibration; sound level and changes; air pressure; light and changes; intrusion; moisture; humidity; inertia/gravitational forces; vehicle (OBD) error codes; vehicle weight; tire pressure; location of the device within the vehicle; engine RPM (and other OBD available data); Time/Date. These interfaces will constantly be saving their data on board as well. As it is recording the video and audio will be time-stamped so it may be viewed in real time or at a later date in conjunction with the vehicle data. In instances where multiple devices collect the same data (such as the speedometer and GPS speed), both may be collected for consistency and accuracy. It is not necessary for all data mentioned above to be collected in every situation, the decision of what to collect and store may be made based on the situation in which the system is being implemented.

The stored interface data as well as the video may be retrieved immediately in the event of an accident. Further the data including the video may be retrieved so long as the video is preserved, providing an extremely accurate account of the performance of that particular vehicle. Further, should a legal claim arise much later, for example at the end of the period of statutory limitations, the interface data will still provide more than sufficient information to recreate any potential anomalies with forensic software well after the video data has been overwritten.

### EXAMPLE 2

### Fruit Freight Transport

Another location in which the present invention might be deployed would be in a freight situations. Particularly one in which the cargo is fragile, such as fruit. In this example cameras might not be necessary, but the other interfaces could preserve and encrypt data related to the transport of a particular cargo or container. Should the container be subjected to anomalous movement, then the data will be noted and flagged for later review. Further, if the company is later informed of a complaint of bruised or battered produce, the company may look back at stored records to determine where the damage was incurred. The present invention might prove extremely useful to commodities companies interested in maintaining the value of their product by providing smooth transportation, this might be particularly important in the transport of fruit or other produce as well as in the case of hazardous substances.

1. A system for acquiring and storing electronic data related to operation of one or more vehicles for later retrieval and evaluation, the system comprising:
one or more devices located on a vehicle that receive raw data comprising one or more of:
vehicle event data, vehicle operation data, video data, and audio data related to said vehicle and its proximity while said vehicle is operated,
and that transmit said raw data to a computer system located on said vehicle wherein said computer system has a processor aided by memory;
wherein said on-board computer system simultaneously receives said raw data from said one or more devices through inputs of said computer system and then processes said raw data with said processor into compressed and encrypted data and then stores said compressed and encrypted data in said memory; and
wherein said compressed and encrypted data can be securely transferred to and archived in a data storage system for use to recreate an alleged vehicle event during a specified time period to determine facts related to a vehicle rider(s) physical experience during said alleged vehicle event.

2. The system of claim 1 wherein said devices include one or more of:
a GPS system;
velocity, acceleration, and braking detection systems;
an interface for the detection of G forces in any direction;
an interface for monitoring wheel direction and steering pitch, roll, and yaw; and
one or more video cameras configured in said vehicle to monitor said vehicle's interior.

3. The system of claim 1 further comprising one or more encryption keys configured to access and authenticate said compressed and encrypted data archived in said data storage system.

4. The system of claim 1 wherein said on-board computer system while processing said raw data into compressed data generates a checksum comprising a combination of a temporal stamp and a hardcoded system ID, wherein said hardcoded system ID identifies said one or more devices which collected said raw data and said vehicle in which said device was located while collecting said raw data.

5. The system of claim 1 further comprising a wired or wireless connection configured to communicate said compressed and encrypted data stored in said memory from said on-board computer through a network to said data storage system.

6. The system of claim 1 further comprising a media input/output configured to transfer said compressed and encrypted data to one or more types of rewritable media comprising a portable hard drive, flash memory device or other re-writable media.

7. The system of claim 1 further comprising one or more decryption keys configured to decrypt said compressed and encrypted data into decrypted data.

8. (canceled)

9. A method for collecting raw data about vehicle operation and/or vehicle event and storing said raw data comprising:
simultaneously acquiring said raw data throughout operation of said vehicle from one or more data sensors located on said vehicle and then transmitting said raw data to an on-board computer system located on said vehicle;
wherein said raw data comprises one or more of vehicle event data, vehicle operation data, time data, location data and passenger data captured by video, and wherein said on-board computer system comprises a processor aided by memory;
processing said raw data with said processor of said on-board computer system into encrypted data and applying a checksum to said encrypted data, said checksum comprising a combination of a temporal stamp and a hardcoded system ID, wherein said hardcoded system ID identifies said one or more devices that collected said raw data and said vehicle on which said device was located while collecting said raw data;
storing said encrypted data in said memory of said on-board computer system; and
using said encrypted data to recreate an alleged vehicle event during a specified time period to determine facts related to a vehicle rider(s) physical experience during said alleged vehicle event.

10. The method of claim 9 further comprising transmitting said encrypted data from said onboard computer system to a computer system located at a remote location.

11. The method of claim 10 further comprising archiving said encrypted data in a secure data storage device.

12. The method of claim 11 further comprising decrypting said encrypted data archived in said secure data storage system using one or more decryption keys.

13. The method of claim 12 wherein a first decryption key is maintained by an operator of said vehicle and a second decryption key is maintained by an anonymous party and said second decryption key is released by court order.

14. The method of claim 12 wherein said decrypting step authenticates said encrypted data.

15. The method of claim 9 where said one or more data sensors comprise one or more of a GPS system; velocity, acceleration, and braking detection systems; an interface for the detection of G forces in any direction; an interface for monitoring wheel direction and steering pitch, roll, and yaw; and one or more video cameras positioned in said vehicle to collect video of its interior.

16. The method of claim 9 wherein said passenger data is stored separately in said memory of said computer system from other of said raw data.

17. The method of claim 9 further comprising analyzing decrypted data related in time and location to said vehicle event to determine any vehicle operation anomaly.

18. The method of claim 17 further comprising analyzing said video data related in time and location to said vehicle event to determine exposure of a passenger(s) of said vehicle to vehicle swerves, acceleration and or deceleration, sudden stops and/or unexpected movement.
